(19) United States
(12) Patent Application Publication
(10) Pub. No.: US 2025/0059943 A1
(43) Pub. Date: Feb. 20, 2025

(54) BUSHING FOR CONNECTING A ROTOR BLADE TO A ROTOR HUB IN A WIND TURBINE

(71) Applicant: Vestas Wind Systems A/S, Aarhus N. (DK)

(72) Inventor: Stephen Randall, Cowes, Isle Of Wight (GB)

(73) Assignee: Vestas Wind Systems A/S, Aarhus N. (DK)

(21) Appl. No.: 18/721,915

(22) PCT Filed: Dec. 20, 2022
(86) PCT No.: PCT/DK2022/050290

§ 371 Date: Jun. 20, 2024

(30) Foreign Application Priority Data
Dec. 21, 2021 (DK) PA202170644

(51) Int. Cl. F03D 1/06

(52) U.S. Cl. CPC F03D 1/066; F05B 2230/50

(57) ABSTRACT

A bushing (42, 92) for connecting a wind turbine blade (20) to a rotor hub (18) of a wind turbine (10) including a main body (44, 94) defining a connecting end of the bushing (42, 92) for receiving a fastener (130) for securing the blade (20) to the rotor hub (18), a tubular extension (46, 96) extending distally from the main body (44, 94) and defining a tip end of the bushing (42, 92) and a central bore (52, 102) extending from the connecting end to the tip end of the bushing (42, 92) and defining a central axis (94, 104) of the bushing (42, 92). The tubular extension (46, 96) includes one or more tapered or cylindrical sections (74,124) and a tip section (76, 126) distal of the one or more tapered or cylindrical sections (74, 124) and adjacent the tip end. The tip section (76, 126) includes an outer surface and an inner surface that are substantially parallel to each other and substantially parallel to the central axis (94, 104) of the bushing (42, 92).

### TECHNICAL FIELD

The invention relates generally to wind turbines, and more particularly to an improved bushing positioned in the root end of a wind turbine blade for connecting the rotor blade to a rotor hub of a wind turbine.

### Background

Wind turbines are used to produce electrical energy using a renewable resource and without combusting a fossil fuel. Generally, a wind turbine converts kinetic energy from the wind into electrical power. A horizontal-axis wind turbine includes a tower, a nacelle located at the apex of the tower, and a rotor having a central hub and a plurality of blades coupled to the hub and extending outwardly therefrom. The rotor is supported on a shaft extending from the nacelle, which shaft is either directly or indirectly operatively coupled with a generator which is housed inside the nacelle. Consequently, as wind forces the blades to rotate, electrical energy is produced by the generator.

In recent years, wind power has become a more attractive alternative energy source and the number of wind turbine, wind farms, etc. has significantly increased, both on land and offshore. Additionally, the size of wind turbines has also significantly increased, with modern wind turbine blades extending between 80 to 100 meters in length and is expected to further increase in the future. The increased length in the wind turbine blades has introduced a number of interesting design considerations for wind turbine designers and manufacturers. For example, with increasing blade length, the joint between the wind turbine blade to the rotor hub may experience increased stresses that present challenging design considerations in order to ensure that the joint can withstand the loads expected during the operating life of the wind turbine. For example, the stresses on the blade-hub joint are considerable, owing chiefly to blade mass and wind force, as well as the effect of continuous rotation of the rotor, which tends to vary the degree and direction of the forces on the blade with every rotation of the rotor. Vibrations in the system can also be considerable.

Conventional joints between wind turbine rotor blades and the rotor hub include threaded stud bolts coupled to and extending from the root end of the wind turbine blade, which are in turn coupled to a pitch bearing associated with the rotor hub. Wind turbine blades are typically made from one or more composite materials formed from fibrous material and resin. Such materials generally do not have the structural integrity to provide a secure fixing mechanism into which the threaded stud bolts may be directly inserted. For example, a hole or bore could be tapped into the composite material at the root end of the rotor blade to provide a complementing thread upon which the stud bolt may achieve a connection. However, the composite material has insufficient shear strength to transfer the loads between the blades and hub via the stud bolts and deterioration of the composite material at the interface would occur.

For this reason, it is generally known to utilize internally threaded metal bushings at the interface between the threaded stud bolts and the composite material at the root end of the wind turbine blade. In one approach, bores may be formed along the circumference of the root end of the wind turbine blade. The metal bushings may then be positioned within the bores and adhesively bonded therein to essentially embed the metal bushings within the composite material of the rotor blade. In another approach, the metal bushings may be embedded within a composite material, which collectively form an insert (separate from the blade). The composite/metal inserts may then be positioned within the bores formed along the root end of the wind turbine blade. The bushings/inserts from these approaches are generally referred to as bonded inserts, due to their bonding within tapped bores of an otherwise formed wind turbine blade. WO 2017/101943 and WO 2021/155896, both of which are owned by the owner of the present invention, illustrate exemplary bonded inserts.

In a more recent approach, the metal bushings have been embedded within a composite material to form an insert (again separate from the blade), and a plurality of such inserts positioned within a mould in abutting and interlocking fashion as part of the fiber lay-up process for manufacturing the blade shells that form the wind turbine blade. The inserts are then integrated within the blade shells through a resin infusion moulding process, such as vacuum infusion. The inserts from this approach are generally referred to as interlocking inserts, due to their arrangement within the moulds during blade manufacturing. WO 2019/110071, which is owned by the owner of the present invention, illustrates an exemplary interlocking insert.

Regardless of the particular approach, the stud bolts are then threadably engaged with the metal inserts positioned in the root end of the blade and then connected to the rotor hub to secure the blade to the wind turbine. The forces between the rotor blade and rotor hub act through the stud bolts, and thus are transferred via the metal bushings, which operate to more uniformly distribute the forces over the interface area with the softer composite material. The force distribution characteristics provided by the metal bushings in turn provide a connection joint with a structural integrity sufficient to provide a secure connection between the rotor hub and rotor blade during use.

While current connection joints are sufficient to achieve their intended purpose of supporting the loads between the rotor blades and rotor hub, manufacturers have concerns on how to address the further anticipated increases in the size of wind turbine blades. One approach may rely on scaling the connection joint to accommodate the larger wind turbine blade, i.e., increase the size of the connection joint. In this approach, the size of the blade at the root end would have to be increased (e.g., larger and larger diameters) and the size of the hub and pitch bearing would have to be increased as well, all of which results in significant increases in material and manufacturing costs. Additionally, the number, length and/or diameter of the metal inserts would have to correspondingly increase so as to accommodate the increased loads at the connection joint. This again increases material and manufacturing costs. Thus, scaling has some limitations for accommodating larger wind turbine blades.

Accordingly, manufacturers are seeking a different solution for accommodating the future increased size of wind turbine blades. For example, an alternative approach may include improving the strength characteristics of the connection joint without a corresponding increase in the size of the connection joint. In this regard, most bushings have a tapered configuration toward the distal end of the bushing to reduce stress concentrations at that location. However, the tapered ends of the bushings may operate as crack initiation sites and are subject to significant shear and peel loads that facilitate crack propagation and ultimately a weakening or failure of the connection joint. Thus, in this alternative approach, manufacturers seek to reduce the shear and peel loads acting at the ends of the bushings to thereby improve the strength characteristics of the connection joint.

### SUMMARY

To address these and other drawbacks, and in a first aspect of the invention, an improved bushing for connecting a wind turbine blade to a rotor hub of a wind turbine is disclosed which seeks to reduce the shear and peel forces acting at the tip of the bushing. According to this aspect, the bushing includes a main body defining a connecting end of the bushing for receiving a fastener for securing the blade to the rotor hub, a tubular extension extending distally from the main body and defining a tip end of the bushing, and a central bore extending from the connecting end to the tip end of the bushing and defining a central axis of the bushing. The tubular extension includes one or more tapered or cylindrical sections and a tip section distal of the one or more tapered or cylindrical sections and adjacent the tip end. The tip section includes an outer surface and an inner surface that are substantially parallel to each other and substantially parallel to the central axis of the bushing. The tip section geometry is configured to reduce the shear forces and peel forces (i.e. resistant to pull out forces) acting at the tip end of the bushing.

In one embodiment, the tubular extension includes at least one tapered section having an outer surface and an inner surface, where at least one of the outer surface and the inner surface defines an acute taper angle relative to the central axis of the bushing. By way of example, the at least one tapered section may include a plurality of tapered sections (e.g., a first and second tapered section), wherein the taper angle of the at least one of the outer surface and the inner surface changes for each of the plurality of tapered sections. In an exemplary embodiment, the taper angle of the at least one of the outer surface and the inner surface may decrease in a direction toward the tip section of the bushing. In one embodiment, both the outer surface and the inner surface of the at least one tapered section defines an acute taper angle relative to the central axis of the bushing. Thus, in this embodiment, the outer surface converges toward the central axis of the bushing along the at least one tapered section and the inner surface diverges away from the central axis of the bushing along the at least one tapered section. Where both the outer surface and the inner surface of the at least one tapered section define an acute taper angle in combination with the tip section having parallel surfaces, this leads to low peel forces in the tip end and reduced peel forces on the outer and inner surfaces of the tapered section.

The tip section may have a length between about 10 mm and about 20 mm and a wall thickness between about 1 mm and about 3 mm.

The tubular extension may additionally include a radiused chamfer distal of the tip section which defines the tip end. The radiused chamfer may have a length of less than 5 mm, such as between about 1 mm and about 3 mm.

In a second embodiment, the tubular extension includes at least one cylindrical section (e.g., a single cylindrical section) having an outer surface and an inner surface, wherein the outer surface has an undulating profile defining a series of peaks and troughs. The undulating profile in combination with the tip section having parallel surfaces leads to improved load transfer as the undulating profile provides an interlocking arrangement with surrounding material, and the parallel surfaces of the tip section leads to reduced peel forces at the tip. By way of example, the undulating profile may be wave-like and be characterized as having an amplitude and wavelength. In one embodiment, the wavelength of the undulating profile is configured to increase in a direction toward the tip section of the bushing. Moreover, in one embodiment, the amplitude of the undulating profile is configured to decrease in a direction toward the tip section of the bushing. In one embodiment, the inner surface of the at least one cylindrical section is substantially parallel to the central axis of the bushing. Providing the inner surface so that is substantially parallel to the central axis of the bushing is beneficial as it allows a core material to be easily inserted into the central bore, in particular, the core material can have a constant cross section. The inner surface of the at least one cylindrical section being substantially parallel to the central axis of the bushing also reduces peel forces at the inner surface.

A web may extend across the central bore adjacent the tip end of the bushing to define a proximal bore portion and a distal bore portion along the at least one cylindrical section. The diameter of the distal bore portion may be greater than the diameter of the proximal bore portion, and the length of the distal bore portion may be less than the length of the proximal bore portion. The tip section may have a length between about 10 mm and about 20 mm and a wall thickness between about 5 mm and about 10 mm. The inner surface of the tip section may include a chamfer adjacent the tip end.

An insert for integration into a root end of a wind turbine blade is also disclosed according to a second aspect of the invention. The insert according to this aspect includes the bushing according to the first aspect described above. In one embodiment, the insert further includes composite material bonded with at least a portion of the bushing. In one embodiment, the bushing may be a bonded insert configured to be adhesively bonded within a bore formed in the root end of the wind turbine blade. In another embodiment, the bushing may be an interlocking insert configured to be integrated within the root end of the wind turbine blade during the moulding process for making the blade.

In a further aspect, a wind turbine blade having a root end and a tip end is disclosed. According to this aspect, the blade includes a plurality of inserts according to the second aspect each embedded within the root end of the blade.

In another aspect, a method of integrating an insert into a root end of a wind turbine blade is disclosed. According to this aspect, the method includes forming a plurality of bores in an end face of the root end of the wind turbine blade, positioning an insert according to the second aspect into each of the plurality of bores, and bonding the inserts within the plurality of bores.

In yet another aspect, another method of integrating an insert into a root end of a wind turbine blade is disclosed. According to this aspect, the method includes providing a mould for forming a shell of the wind turbine blade, laying up fibrous material in the mould, positioning a plurality of inserts according to the second aspect in the mould, and infusing resin in the mould to form the blade shell.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a wind turbine in which embodiments of the invention may be used;

FIG. 2 is a perspective view of a wind turbine blade and rotor hub having a connection joint in accordance with an embodiment of the invention;

FIG. 3 is an enlarged perspective view of a root end of a wind turbine blade according to an embodiment of the invention;

FIG. 4 is a top plan view of a bushing for an insert of a wind turbine blade in accordance with an embodiment of the invention;

FIG. 5 is a cross-sectional view of the bushing shown in FIG. 4;

FIG. 6 is a cross-sectional view of the bushing of FIG. 4 embedded in a root end of a wind turbine blade;

FIG. 7 is an enlarged cross-sectional view of the bushing shown in FIG. 5 adjacent its tip end;

FIG. 8 is a top plan view of a bushing for an insert of a wind turbine blade in accordance with another embodiment of the invention;

FIG. 9 is a cross-sectional view of the bushing shown in FIG. 8; and

FIG. 10 is an enlarged view of the bushing shown in FIG. 8 adjacent its tip end.

### DETAILED DESCRIPTION

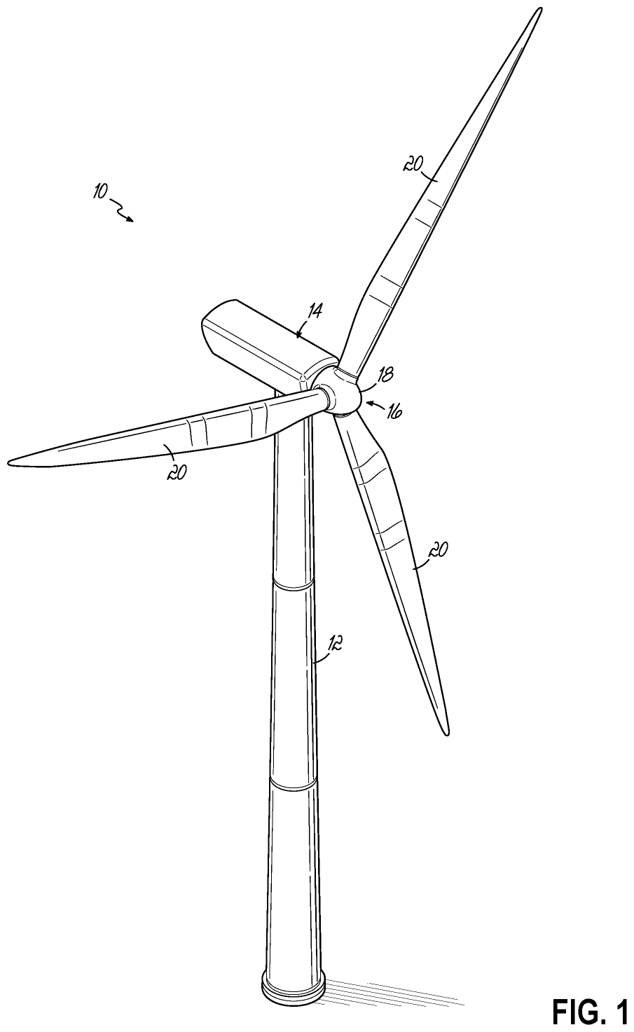

With reference to FIG. 1, a wind turbine 10 includes a tower 12, a nacelle 14 disposed at the apex of the tower 12, and a rotor 16 operatively coupled to a generator (not shown) housed inside the nacelle 14. In addition to the generator, the nacelle 14 may house various components needed to convert wind energy into electrical energy and to operate and optimize the performance of the wind turbine 10. The tower 12 supports the load presented by the nacelle 14, rotor 16, and other wind turbine components housed inside the nacelle 14 and operates to elevate the nacelle 14 and rotor 16 to a height above ground level or sea level, as may be the case, at which air currents having lower turbulence and higher velocity are typically found.

The rotor 16 may include a central rotor hub 18 and a plurality of blades 20 attached to the central hub 18 at locations distributed about the circumference of the central hub 18. In the representative embodiment, the rotor 16 includes three blades 20, however the number may vary. The blades 20, which project radially outward from the central rotor hub 18, are configured to interact with passing air currents to produce rotational forces that cause the central hub 18 to spin about its longitudinal axis. The design, construction, and operation of the blades 20 are familiar to a person having ordinary skill in the art of wind turbine design and may include additional functional aspects to optimize performance. For example, pitch angle control of the blades 20 may be implemented by a pitch control mechanism (not shown) responsive to wind velocity to optimize power production in low wind conditions, and to feather the blades if wind velocity exceeds design limitations.

The rotor 16 may be coupled to the gearbox directly or indirectly via a main shaft extending between the rotor hub 18 and the gearbox. The main shaft rotates with the rotor 16 and is supported within the nacelle 14 by a main bearing support which supports the weight of the rotor 16 and transfers the loads on the rotor 16 to the tower 12. The gearbox transfers the rotation of the rotor 16 through a coupling to the generator. Wind exceeding a minimum level may activate the rotor 16, causing the rotor 16 to rotate in a direction substantially perpendicular to the wind, applying torque to the input shaft of the generator to produce electricity.

The wind turbine 10 may be included among a collection of similar wind turbines belonging to a wind farm or wind park that serves as a power generating plant connected by transmission lines with the power grid, such as a three-phase alternating current (AC) power grid. The electrical power produced by the generator may be supplied to a power grid (not shown) or an energy storage system (not shown) for later release to the grid as understood by a person having ordinary skill in the art. The power grid generally consists of a network of power stations, transmission circuits, and substations coupled by a network of transmission lines that transmit the power to loads in the form of end users and other customers of electrical utilities.

As mentioned above, for certain wind turbine designs, the wind turbine blades 20 are coupled to the rotor hub 18 in a manner that allows the blades 20 to rotate or pitch about a longitudinal axis of the blades 20. This is achieved by coupling a root end 22 of a blade 20 to a pitch bearing 24 operatively coupled to the rotor hub 18. The pitch bearing 24 generally includes a ring rotatable relative to the hub 18 to which the root end 22 of the blade 20 is coupled. Pitch bearings are generally well known in the art and thus will not be described in further detail herein.

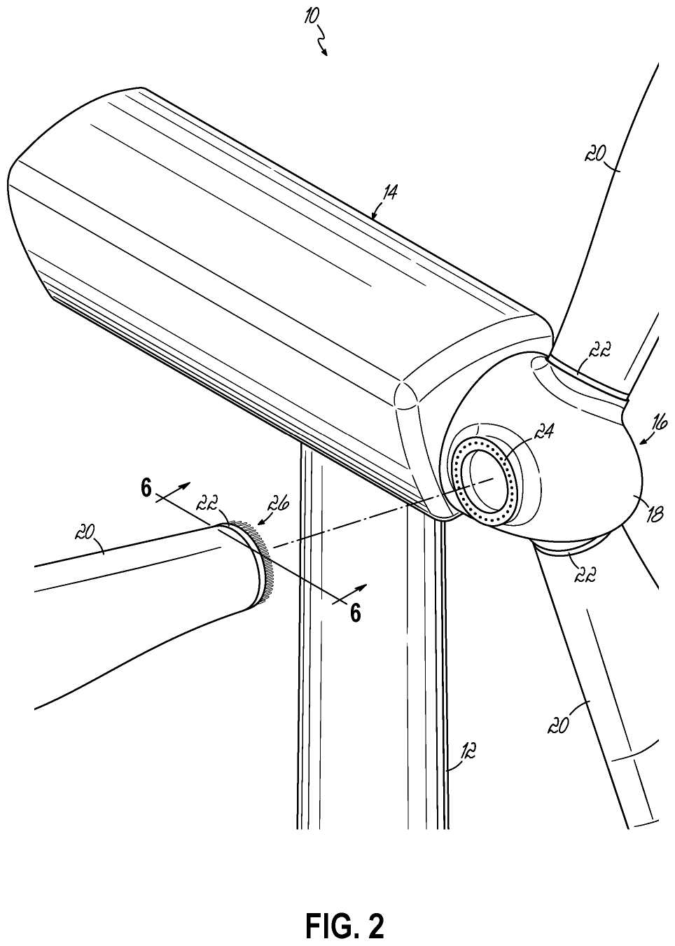

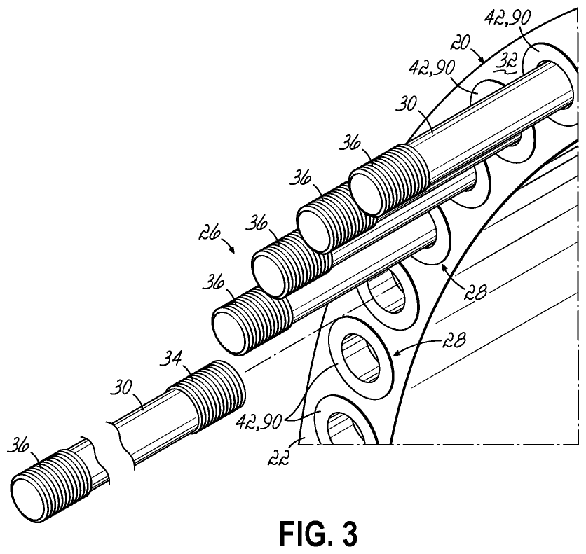

As illustrated in FIGS. 2 and 3, a connection joint 26 between a wind turbine blade 20 of the wind turbine 10 and the rotor hub 18 includes a plurality of inserts 28 coupled to the wind turbine blade 20 at the root end 22 thereof, and a plurality of stud bolts 30 configured to be coupled to the inserts 28 in the wind turbine blade 20 and further configured to be coupled to the rotor hub 18 (FIG. 2), such as through the pitch bearing 24. As illustrated in FIG. 3, the inserts 28 may be circumferentially spaced about an end face 32 at the root end 22 of the blade 20 and embedded within the material of the blade 20 such that a connecting end of the inserts 28 slightly protrudes (e.g., about 5 mm) from the end face 32 of the blade 20. The inserts 28 will be described more fully below. The number of inserts 28 along the circumference of the root end 22 of the wind turbine blade 20 depends on the size of the blade, among potential other factors, but may be anywhere from 120 to 240 (e.g., 180) inserts for blades between 80 meters and 100 meters in length. However, it should be realized that more or fewer inserts 28 may be used depending on the specific application and needs of the manufacturer.

The stud bolts 30 are generally cylindrical elongate members having a threaded blade end 34 and a threaded hub end 36. As illustrated in FIG. 2, during assembly of the wind turbine 10, the stud bolts 30 are threadably engaged with the inserts 28 at the root end 22 of the wind turbine blade 20 such that the threaded hub end 36 of the stud bolts 28 extends away from the root end 22 of the blade 20. The stud bolts 30 are then aligned with corresponding holes in the pitch bearing 24 on the rotor hub 18, inserted therethrough, and secured to the pitch bearing 24 via a threaded fastener or the like. Through the connection joint 26, a wind turbine blade 20 may be securely coupled to the rotor hub 18 of the wind turbine 10 and generally accommodates the loads applied to the wind turbine blades 20 during the operational life of the wind turbine 10.

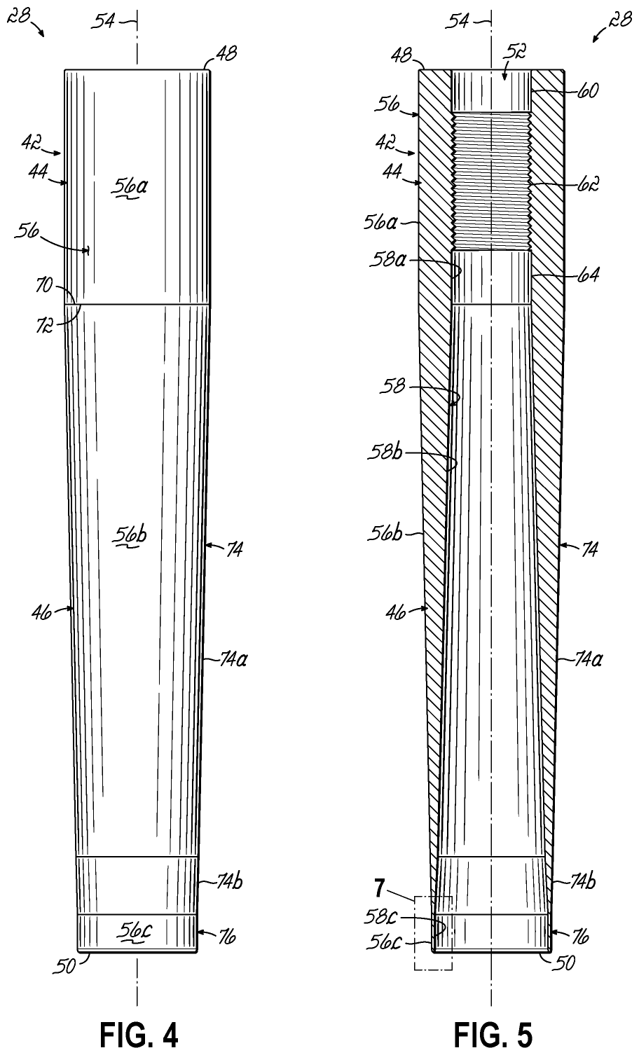

As noted above, whether the inserts 28 are bonded inserts or interlocking inserts, the inserts 28 include a bushing, such as a metal bushing, embedded in the material of the wind turbine blade 20 adjacent the root end 22 and configured to interface with the blade end 34 of the stud bolts 30. FIGS. 4-6 illustrate an insert 28 configured as a bonded insert and having a bushing 42 in accordance with an embodiment of the invention. The bushing 42 generally includes a main body 44 and a tubular extension 46 projecting from an end of the main body 44 and configured to engage with composite material associated with the insert 28 (in the event the insert includes composite material) and/or the wind turbine blade 20 along the outer surface of the main body 44 and along the inner and outer surfaces of the tubular extension 46. The bushing 42 includes a connecting end 48, a tip end 50 and a central bore 52 extending from the connecting end 48 to the tip end 50 and defining a central axis 54 of the bushing 42. The bushing 42 defines an outer surface 56 and the central bore 52 defines an inner surface 58, and it is these surfaces that are configured to engage with the composite material to secure the bushing 42 within the material of the wind turbine blade 20.

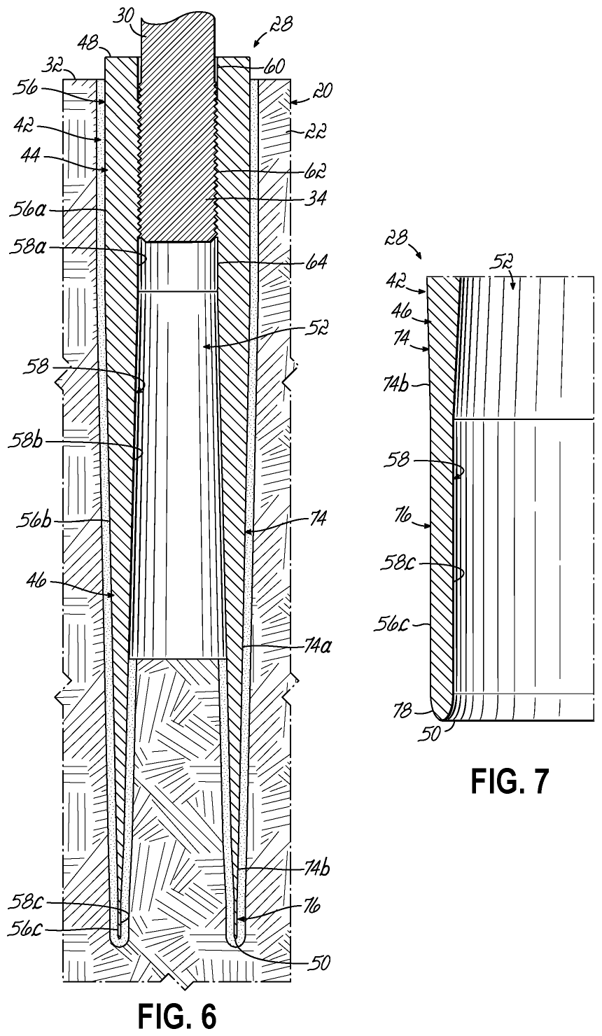

The central bore 52 extends inwardly from the connecting end 48 and is configured to receive a stud bolt 30 therein, as illustrated in FIG. 6. The central bore 52 includes a first inlet portion 60 adjacent the connecting end 48, a second threaded portion 62 adjacent the inlet portion 60, and a third expansion portion 64 adjacent the threaded portion 62. The inlet portion 60 is generally circular in cross section, has smooth side walls, and is sized so as to receive the stud bolt 30 therein. The length of the inlet portion 60 along the central bore 52 may be between about 0.25D and about 2D, where D is the major diameter of the threaded blade end 34 of the stud bolt 30 configured to be received in the central bore 52. In one embodiment, for example, the length of the inlet portion 60 may be between about 20 mm and about 30 mm. It should be recognized, however, that other lengths are also possible and remain within the scope of the present invention.

The threaded portion 62 includes internal threads configured to mesh with the threads on the blade end 34 of the stud bolt 30. By way of example and without limitation, the threaded portion 62 may be configured to receive a M20-M50 threaded stud bolt 30 (and preferably about an M42 threaded bolt) and have a length along the central bore 52 between about 0.5D and about 3D. In one embodiment, for example, the length of the threaded portion 62 may be between about 60 mm and about 90 mm. Other lengths may also be possible, and the invention is not limited to the range above.

Lastly, the expansion portion 64 has a cross dimension greater than that of the threaded portion 62, wherein the increase in the size of the cavity immediately adjacent the threads is configured to reduce the stress concentrations at the first thread and more evenly distribute the forces over several threads. In an exemplary embodiment, the expansion portion 64 may be generally cylindrical with a diameter greater than the diameter of the threaded portion 62. For example, the diameter of the expansion portion 64 may be between about 5% and about 50% greater than the diameter of the threaded portion 62. Moreover, the length of the expansion portion 64 along the central bore 52 may be between 0.1D and 1D in various embodiments. In one embodiment, for example, the length of the expansion portion 64 may be between about 20 mm and about 40 mm. It should be recognized, however, that the diameter and length may have other values and remain within the scope of the present invention.

In an exemplary embodiment, the main body 44 of the bushing 42 may be generally cylindrical, wherein the outer surface 56a of the main body 44 may be generally parallel to the central axis 54 of the bushing 42. Moreover, the main body 44 may be sized such that the outer surface 56a has a diameter between about 1.5D and about 3D. In one embodiment, for example, the outer diameter of the main body 44 may be between about 65 mm and about 85 mm. However, the size of the main body 44 may be smaller or larger than that provided above. Additionally, the length of the main body 44 may be between about 0.4D and about 6D. In one embodiment, for example, the length of the main body 44 may be between about 100 mm and about 150 mm. The length may also have other values outside of this range. In an exemplary embodiment, the main body 44 may be formed from a metal, such as steel. However, it should be recognized that in alternative embodiments, other types of metals, or even other suitably strong non-metal materials, may be used to form the main body 44 of the bushing 42.

In an exemplary embodiment, the tubular extension 46 has a proximal end 70 coupled to a distal end 72 of the main body 44 and extends away from the main body 44 to the tip end 50 of the bushing 42. The tubular extension 46 includes outer surface 56b and inner surface 58b that is defined by the central bore 52. The tubular extension 46 may be sized so that the outer surface 56b of the tubular extension 72 at the proximal end 70 aligns or smoothly mates with the outer surface 56a of the main body 44 at its distal end 72. In a similar manner, the central bore 52 may be sized so that the inner surface 58b of the tubular extension 46 at the proximal end 70 aligns or smoothly mates with the inner surface 58a of the main body 44 at its distal end 72. Additionally, the length of the tubular extension 46 may be between about 2D and about 10D. In one embodiment, for example, the length of the tubular extension 46 may be between about 300 mm and about 400 mm. However, other lengths are also possible. In an exemplary embodiment, the tubular extension 46 may be formed from a metal, such as steel. However, it should be recognized that in alternative embodiments, other types of metals, or even other suitably strong non-metal materials may be used to form the tubular extension 46 of the bushing 42. In one embodiment, the main body 44 and the tubular extension 46 of the bushing 42 may have a two-part construction where the parts are separately formed and connected together in an end-to-end fashion. In another embodiment, and perhaps a preferred embodiment, the bushing 42 may be formed as a unitary member where the main body 44 and the tubular extension 46 may be integrally formed together as a monolithic member.

As illustrated in FIGS. 4-6, the tubular extension 46 may include at least one generally conical or tapered section 74 extending from the main body 44 and a tip section 76 adjacent the tip end 50 of the bushing 42. A taper may be formed in the outer surface 56b, the inner surface 58b, or both the outer and inner surfaces 56b, 58b of the tubular extension 46 along the at least one tapered section 74. In preferred embodiment, a taper may be formed in both the outer surface 56b and the inner surface 58b of the tubular extension 46 along the at least one tapered section 74.

In an exemplary embodiment, the tubular extension 46 may include two tapered sections 74a, 74b, but there may be fewer or more tapered sections depending on the particular application. In each of the tapered sections 74a, 74b, the outer surface 56b and/or the inner surface 58b forms an acute taper angle relative to the central axis 54 of the bushing 42. In this regard, the outer surface 56b along each of the taper sections 74a, 74b may taper inward toward the central axis 54 in a range between about 0.25 degrees and about 10 degrees. For example, the taper angle in the outer surface 56b in the first tapered section 74a may be about one degree and the taper angle in the outer surface 56b of the second tapered section 74b may be about 0.5 degrees. Similarly, the inner surface 58b along each of the taper sections 74a, 74b may taper outwardly away from the central axis 54 in a range between about 0.25 degree and about 10 degrees. For example, the taper angle in the inner surface 58b in the first tapered section 74a may be about one degree and the taper angle in the inner surface 58b of the second tapered section 74b may be about 0.5 degrees. Thus, the wall thickness of the tubular extension 46 along the at least one tapered section 74 may decrease in a direction from the proximal end 70 toward the tip section 76 adjacent the tip end 50 of the bushing 42. By way of example, the wall thickness may decrease between about 10% and about 90% from the proximal end 70 to the tip section 76. In one embodiment, for example, the wall thickness may decrease by greater than about 80%. A reduction less than this value, however, may also be possible.

In one embodiment, the taper angle of the outer surface 56b and/or the inner surface 58b may be generally constant along the length of the at least one tapered section 74. Alternatively, the taper angle of the outer surface 56b and/or the inner surface 58b may vary along the length of each of the at least one tapered section 74. Moreover, in each of the at least one tapered section 74, the taper angle of the outer surface 56b and the taper angle of the inner surface 58b may be the same or may be different from each other. Furthermore, when there are at least two tapered sections 74, each tapered section 74a, 74b may have a (slightly) different taper angle in the outer surface 56b, the inner surface 58b, or in both outer and inner surfaces 56b, 58b relative to an adjacent tapered section 74. For example, in one embodiment, for each tapered section the taper angle may progressively decrease in a direction toward the tip section 76. The transition between the tapered sections 74a, 74b and the transition between the second tapered section 74b and the tip section 76 may be smooth.

Turning now to the tip section 76, and as illustrated in FIG. 7, this section has a specific geometry configured to reduce the shear and peel forces at the tip of the bushing 42. More particularly, along the tip section 76, the outer surface 56c and the inner surface 58c of the bushing 42 are configured to be substantially parallel to each other. More particularly, in an exemplary embodiment, the outer surface 56c and the inner surface 58c may be configured to be substantially parallel to the central axis 54 of the bushing 42. Thus, for example, in this embodiment the taper angle of the outer surface 56c may be substantially zero degrees and the taper angle of the inner surface 58c may be substantially zero degrees. The length of the tip section 76 may be between about 0.1D and about 1D. In one embodiment, for example, the length of the tip section 76 may be between about 10 mm and about 20 mm. It should be recognized, however, that other lengths for the tip section 76 may also be possible. Moreover, the wall thickness of the bushing 42 along the tip section 76 may be between about 0.02D and about 0.07D. In one embodiment, for example, the wall thickness along the tip section 76 may be between about 1 mm and about 3 mm. However, other thicknesses may also be possible. In an exemplary embodiment, the bushing 42 may include a radiused chamfer 78 just distal of the tip section 76 to define the tip end 50 of the bushing 50. The radiused chamfer 78 may have a length between about 0.02D and about 0.07D. In one embodiment, for example, the length of the radiused chamfer 78 may be between about 1 mm and about 3 mm.

It is believed that the geometry of the tubular extension 46, and more particularly the tapered geometry of the at least one tapered section 74 followed by the parallel geometry of the tip section 76 reduces the stresses (e.g., peel loads) at the tip end 50 of the bushings 42, thereby reducing crack initiation and propagation that weakens the connection joint 26 between the wind turbine blade 20 and the rotor hub 18. The result is a stronger connection joint 26 between the two that is capable of withstanding greater loads without a corresponding increase in the size of the connection joint 26. Thus, it may be possible to accommodate longer wind turbine blades 20 without a corresponding increase in the size of the connection joint 26.

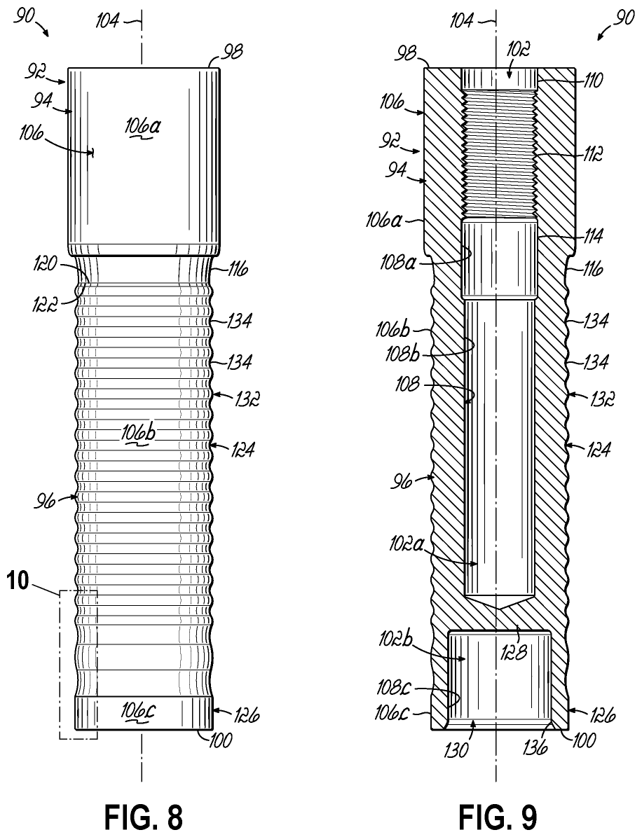

While the above insert 28, and more particularly the bushing 42, shown and described above was directed to a bonded type of insert, aspects of the invention are not so limited. For example, it is contemplated that the tip section geometry described above may also prove beneficial in interlocking type of inserts. In this regard, FIGS. 8-10 illustrate another insert 90 configured as an interlocking insert and having a bushing 92 in accordance with another embodiment of the invention. The bushing 92 generally includes a main body 94 and a tubular extension 96 projecting from an end of the main body 94 and configured to engage with composite material or core material associated with the insert 90 along the outer surface of the main body 94 and along the inner and outer surfaces of the tubular extension 96. The bushing 92 includes a connecting end 98, a tip end 100 and a central bore 102 extending from the connecting end 98 to the tip end 100 and defining a central axis 104. The bushing 92 defines an outer surface 106 and the central bore 102 defines an inner surface 108, and it is these surfaces that are configured to engage with the composite material or core material of the insert 90.

The central bore 102 extends inwardly from the connecting end 98 and is configured to receive a stud bolt 30 therein, similar to the above. The central bore 102 includes a first inlet portion 110 adjacent the connecting end 98, a second threaded portion 112 adjacent the inlet portion 110, and a third expansion portion 114 adjacent the threaded portion 112. The inlet portion 110 is generally circular in cross section, has smooth side walls, and is sized so as to receive the stud bolt 30 therein. The length of the inlet portion 110 along the central bore 52 may be between about 0.25D and about 2D, where D is the major diameter of the threaded blade end 34 of the stud bolt 30 configured to be received in the central bore 102. In one embodiment, for example, the length of the inlet portion 110 may be between about 9 mm and about 15 mm. It should be recognized, however, that other lengths are also possible and remain within the scope of the present invention.

The threaded portion 112 includes internal threads configured to mesh with the threads on the blade end 34 of the stud bolt 30. By way of example and without limitation, the threaded portion 112 may be configured to receive a M20-M50 threaded stud bolt 30 (and preferably about an M36 threaded bolt) and have a length along the central bore 102 between about 0.5D and about 3D. In one embodiment, for example, the length of the threaded portion 112 may be between about 50 mm and about 70 mm. However, other lengths may also be possible, and the invention is not limited to the range above.

Lastly, the expansion portion 114 has a cross dimension greater than that of the threaded portion 112, wherein the increase in the size of the cavity immediately adjacent the threads is configured to reduce the stress concentrations at the first thread and more evenly distribute the forces over several threads. In an exemplary embodiment, the expansion portion 114 may be generally cylindrical with a diameter greater than the diameter of the threaded portion 112. For example, the diameter of the expansion portion 114 may be between about 5% and about 50% greater than the diameter of the threaded portion 112. Moreover, the length of the expansion portion 114 along the central bore 102 may be between 0.1D and 1.5D in various embodiments. In one embodiment, for example, the length of the expansion portion 114 may be between about 20 mm and about 50 mm. It should be recognized, however, that the diameter and length may have other values and remain within the scope of the present invention.

The main body 94 of the bushing 92 may be generally cylindrical and the outer surface 106a of the main body 94 may be generally parallel to the central axis 104 of the bushing 92. Moreover, the main body 94 may be sized such that the outer surface 106a is between about 1.5D and about 3D. In one embodiment, for example, the outer diameter of the main body 94 may be between about 60 mm and about 80 mm. The size of the main body 94 may, however, be smaller or larger than that provided above. Additionally, the length of the main body 94 may be between about 0.4D and about 6D. In one embodiment, for example, the length of the main body 94 may be between about 100 mm and about 150 mm. The length may also have other values outside of this range, however. In one embodiment, the outer surface 106a may include a neck region 116 adjacent a distal end 122 of the main body 94 having a size slightly less than the more proximal portions of the main body 94. For example, the neck region 116 may have a diameter that is reduced between about 5% and about 15% of the outer diameter of the main body 94. In an exemplary embodiment, the main body 94 may be formed from a metal, such as steel. However, it should be recognized that in alternative embodiments, other types of metals, or even other suitably strong non-metal materials, may be used to form the main body 94 of the bushing 92.

In an exemplary embodiment, the tubular extension 96 has a proximal end 120 coupled to a distal end 122 of the main body 94 and extends away from the main body 94 to the tip end 100 of the metal bushing 92. The tubular extension 96 includes outer surface 106b and inner surface 108b that is defined by the central bore 102. The tubular extension 96 may be sized so that the outer surface 106b of the tubular extension 96 at the proximal end 120 aligns or smoothly mates with the outer surface 106a of the neck region 116 of the main body 44 at its distal end 122. In a similar manner, the central bore 102 may be sized so that the inner surface 108b of the tubular extension 96 at the proximal end 120 aligns or smoothly mates with the inner surface 108a of the expansion portion 114 of the main body 94 at its distal end 122. Additionally, the length of the tubular extension 96 may be between about 2D and about 10D. In one embodiment, for example, the length of the tubular extension 96 may be between about 200 mm and 250 mm. However, other lengths are also possible. In an exemplary embodiment, the tubular extension may be formed from a metal, such as steel. However, it should be recognized that in alternative embodiments, other types of metals, or even other suitably strong non-metal materials may be used to form the tubular extension 96 of the bushing 92. In one embodiment, the main body 94 and the tubular extension 96 of the bushing 92 may have a two-part construction where the parts are separately formed and connected together in an end-to-end fashion. In another embodiment, and perhaps a preferred embodiment, the bushing 92 may be formed as a unitary member where the main body 94 and the tubular extension 96 may be integrally formed together as a monolithic member.

As illustrated in FIGS. 8 and 9, the tubular extension 96 may include a generally cylindrical section 124 extending from the main body 94 and a tip section 126 adjacent the tip end 100 of the bushing 92. The cylindrical section 124 includes a web 128 extending across the central bore 102 that divides the central bore 102 into a proximal bore portion 102a and a distal bore portion 102b. In the cylindrical section 124 along the proximal bore portion 102a, the inner surface 108b is generally straight and substantially parallel to the central axis 104 of the bushing 92. In an exemplary embodiment, the diameter of the proximal bore portion 102a may be between about 0.7D and about 1.3D and the length of the proximal bore portion 102a (i.e., from the proximal end 120 of the tubular extension 96 to the web 128) may be between about 2D and about 6D. In one embodiment, for example, the diameter of the proximal bore portion 102a may be between about 30 mm and about 36 mm, and the length of the proximal bore portion 102a may be between about 140 mm and about 160 mm. It should be recognized, however, that other values for the diameter and the length may also be possible.

The distal bore portion 102b defines a cavity 130 configured to receive a core used in the manufacture of the insert 90. As noted above, the details of that manufacturing process are generally known from existing documentation and are beyond the scope of the present disclosure. In the cylindrical section 124 along the distal bore portion 102b, the inner surface 108c is generally straight and substantially parallel to the central axis 104 of the bushing 92. In an exemplary embodiment, the diameter of the distal bore portion 102b may be greater than the diameter of the proximal bore portion 102a and may constitute the maximum diameter along the entire central bore 102. The diameter of the distal bore portion 102b may be between about 1.0D and about 1.7D and the length of the distal bore portion 102b (i.e., from the web 128 to the tip end 100) may be between about 0.5D and about 2D. In one embodiment, for example, the diameter of the distal bore portion 102b may be between about 40 mm and about 60 mm, and the length of the distal bore portion 102b may be between about 20 mm and about 30 mm. Other values for the diameter and the length may also be possible.

Turning now to the outer surface 106b of the cylindrical section 124, FIGS. 8-10 illustrate that the outer surface 106b has an undulating profile 132 defined by a series of peaks and troughs. The troughs, for example, define a plurality of circumferential grooves 134 along the length of the cylindrical section 124 and the peaks define lands between adjacent grooves 134. The purpose of the grooves 134 is to provide better engagement with the surrounding material. In an exemplary embodiment, the undulating profile 132 may be modelled as a wave and be characterized by an amplitude and wavelength. By way of example, the undulating profile 132 may have an amplitude between about 0.01D and about 0.1D and have a wavelength between about 0.1D and about 0.5D. In one embodiment, for example, the amplitude of the undulating profile 132 may be between about 0.5 mm and about 1 mm, and the wavelength of the undulating profile 132 may be between about 5 mm and about 15 mm. Other values for the amplitude and wavelength, however, may be possible and remain within the scope of the present invention. The outer diameter of the cylindrical section 124 may be generally less than the outer diameter of the main body 94 (proximal of the neck region 116). In an exemplary embodiment, the outer diameter of the cylindrical section 124 (e.g., at the peaks of the undulating profile 132) may be between about 1D to about 3D. In one embodiment, for example, the outer diameter of the cylindrical section 124 may be between about 50 mm and about 70 mm. Other values, however, may be possible.

In one embodiment, the wavelength and the amplitude of the undulations on the outer surface 106b may be generally constant along substantially the entire length of the cylindrical section 124. In an alternative embodiment, however, the wavelength and amplitude adjacent a distal end of the cylindrical section 124 may vary from the constant values along the more distal portion of the cylindrical section 124. More particularly, the wavelength of the undulations adjacent the distal end of the cylindrical section may start increasing and the amplitude of the undulations may start decreasing in a direction toward the tip section 126. This variation allows for a smoother transition between the undulating profile 132 of the cylindrical section 124 and the profile of the outer surface along the tip section 126, as will be discussed below. The variation also reduces the peel loads acting at the interface between the outer surface 106b of the bushing 92 and the surrounding material.

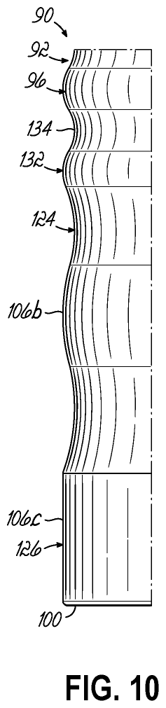

Turning now to the tip section 126, and as illustrated in FIG. 10, this section has a specific geometry configured to reduce the shear and peel forces at the tip end 100 of the bushing 92. More particularly, along the tip section 126, the outer surface 106c and the inner surface 108c of the bushing 92 may be configured to be substantially parallel to each other. In an exemplary embodiment, the outer surface 106c and the inner surface 108c may be configured to be substantially parallel to the central axis 104 of the bushing 92. In exemplary embodiments, the length of the tip section 126 may be between about 0.1D and about 1D. In one embodiment, for example, the length of the tip section 126 may be between about 10 mm and about 20 mm. Other values for the length, however, may be possible. In a further exemplary embodiment, the wall thickness of the bushing 92 along the tip section 126 may be between about 0.1D and about 0.4D. In one embodiment, for example, the wall thickness along the tip section 126 may be between about 5 mm and about 10 mm, but other thicknesses may also be possible. In one exemplary embodiment, the bushing 92 may include a radiused chamfer 136 on the inner surface 108c at the distal tip 100 to facilitate the insertion of a core into the cavity 130.

It is believed that the geometry of the tubular extension 96, and more particularly the undulating geometry of the cylindrical section 124 followed by the parallel geometry of the tip section 126 reduces the stresses (e.g., peel loads) at the tip end 100 of the bushings 92, thereby reducing crack initiation and propagation that weakens the connection joint 26 between the wind turbine blade 20 and the rotor hub 18. The result is a stronger connection joint 26 between the two that is capable of withstanding greater loads without a corresponding increase in the size of the connection joint 26. Thus, it may be possible to accommodate longer wind turbine blades 20 without a corresponding increase in the size of the connection joint.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A bushing for connecting a wind turbine blade to a rotor hub of a wind turbine, comprising:
a main body defining a connecting end of the bushing for receiving a fastener for securing the blade to the rotor hub;
a tubular extension extending distally from the main body and defining a tip end of the bushing; and
a central bore extending from the connecting end to the tip end of the bushing and defining a central axis of the bushing,
wherein the tubular extension includes one or more tapered or cylindrical sections and a tip section distal of the one or more tapered or cylindrical sections and adjacent the tip end, and
wherein the tip section includes an outer surface and an inner surface that are substantially parallel to each other and substantially parallel to the central axis of the bushing.

2. The bushing according to claim 1, wherein the tubular extension includes at least one tapered section having an outer surface and an inner surface, at least one of the outer surface and the inner surface defining an acute taper angle relative to the central axis of the bushing.

3. The bushing according to claim 2, wherein the at least one tapered section includes a plurality of tapered sections, and wherein the taper angle of the at least one of the outer surface and the inner surface changes for each of the plurality of tapered sections.

4. The bushing according to claim 3, wherein the taper angle of the at least one of the outer surface and the inner surface decreases in a direction toward the tip section of the bushing.

5. The bushing according to claim 2, wherein the outer surface and the inner surface of the at least one tapered section defines an acute taper angle relative to the central axis of the bushing.

6. The bushing according to claim 1, wherein the tip section has a wall thickness between about 1 mm and about 3 mm.

7. The bushing according to claim 1, wherein the tubular extension further comprises a radiused chamfer distal of the tip section that defines the tip end.

8. The bushing according to claim 1, wherein the tubular extension includes at least one cylindrical section having an outer surface and an inner surface, the outer surface having an undulating profile defining a series of peaks and troughs.

9. The bushing according to claim 8, wherein the undulating profile includes a wave having an amplitude and wavelength.

10. The bushing according to claim 9, wherein the wavelength increases in a direction toward the tip section of the bushing.

11. The bushing according to claim 9, wherein the amplitude decreases in a direction toward the tip section of the bushing.

12. The bushing according to claim 8, wherein the inner surface of the at least one cylindrical section is substantially parallel to the central axis of the bushing.

13. The bushing according to claim 8, further comprising a web extending across the central bore adjacent the tip end to define a proximal bore portion and a distal bore portion along the at least one cylindrical section.

14. The bushing according to claim 13, wherein the diameter of the distal bore portion is greater than the diameter of the proximal bore portion, and wherein the length of the distal bore portion is less than the length of the proximal bore portion.

15. The bushing according to claim 8, wherein the tip section has a wall thickness between about 5 mm and about 10 mm.

16. The bushing according to claim 1, wherein the tip section has a length between about 10 mm and about 20 mm.

17. An insert for integrating into a root end of a wind turbine blade comprising the bushing according to claim 1.

18. The insert according to claim 17, further comprising composite material bonded with at least a portion of the bushing.

19. A wind turbine blade having a root end and a tip end, the blade comprising a plurality of inserts each according to claim 17 embedded within the root end of the blade.

20. A method of integrating an insert into a root end of a wind turbine blade, comprising:
forming a plurality of bores in an end face of the root end of the wind turbine blade;
positioning an insert according to claim 17 into each of the plurality of bores; and
bonding the inserts within the plurality of bores.

21. A method of integrating an insert into a root end of a wind turbine blade, comprising:
providing a mould for forming a shell of the wind turbine blade;
laying up fibrous material in the mould;
positioning a plurality of inserts according to claim 18 in the mould; and
infusing resin in the mould to form the blade shell.
